(19) United States
(12) Patent Application Publication
(10) Pub. No.: US 2018/0105660 A1
(43) Pub. Date: Apr. 19, 2018

(54) Molded Article, Film, and Method for Preventing Thermal Deformation

(71) Applicant: RIKEN, Saitama (JP)

(72) Inventors: Keiji Numata, Saitama (JP); Kenjiro Yazawa, Saitama (JP)

(73) Assignee: RIKEN, Saitama (JP)

(21) Appl. No.: 15/573,670

(22) PCT Filed: May 12, 2016
(86) PCT No.: PCT/JP2016/064179

§ 371 Date: Nov. 13, 2017

(30) Foreign Application Priority Data
May 14, 2015 (JP) 2015-098720

(51) Int. Cl. C08J 5/18

(52) U.S. Cl. CPC C08J 5/18; C08L 89/00; C08J 2389/00

(57) ABSTRACT

An object of the present invention is to provide a method for preventing a thermal deformation of a molded article and a film produced by molding a structural protein, and the molded article and film prevented from thermal deformation. The thermal deformation of the molded article which is produced by molding the structural protein and has a birefringence of 1.0×10⁻⁵ to 10.0×10⁻⁵ can be prevented by keeping a water content of the molded article within a range from 0 to 8.5% by mass.

### TECHNICAL FIELD

The present invention relates to a molded article, a film, and a method for preventing a thermal deformation thereof, and more particularly to a method for preventing the thermal deformation of the molded article and the film produced by molding a structural protein and the molded article and film prevented from thermal deformation.

### BACKGROUND ART

Since a structural protein “fibroin” contained in silk and spider web has biocompatibility and biodegradability in addition to its robustness, it is increasingly used in medical and cosmetic applications in addition to clothing applications.

For example, Patent Document 1 reported a method for preparing, from a fibroin solution, a transplantable material which may be used for repairment, reinforcement, or replacement of bone, and described that the resultant material has a load bearing capacity comparable to bone at a transplantation site and an absorbability such that the material is gradually decomposed to be replaced by the bone tissue.

In addition, Patent Document 2 reported a method for producing a silk fibroin porous material, which method freezes and then melts a silk fibroin solution prepared by adding an aliphatic carboxylic acid, and also described that the resultant porous material is superior in water absorption and safety and can be widely applied to fields such as cosmetics and esthetics.

### PRIOR ART DOCUMENTS

### Patent Documents

[Patent Document 1] JP-T-2011-525400
[Patent Document 2] JP-A-2012-82244

### SUMMARY OF THE INVENTION

### Technical Problem

Structural proteins such as fibroin desirably insure an enough thermal stability to be used for a structural material in industrial products as alternative of synthetic resins, but the present inventors have revealed that, for example, film-like molded article produced from silk fibroin derived from a silkworm cocoon exhibits glass transition points at about 50° C. and about 180° C., in other words, that it exhibits thermal deformation above about these temperatures.

An object of the present invention is to provide a method for preventing thermal deformation of a molded article produced by molding a structural protein and the molded article prevented from the thermal deformation.

### Solution to Problem

The present inventors have carried out an intense study to solve the above problem, and found that the glass transition point of a molded article produced by molding a structural protein appears when its water content is higher than a certain value, below which thermal deformation is unlikely to occur, and thus they have completed the present invention.

The present invention relates to as follows.
<1> A molded article produced by molding a structural protein, having a birefringence of 1.0'10⁻⁵ to 10.0×10⁻⁵ and a water content of 0 to 8.5% by mass.
<2> The molded article according to <1>, wherein the structural protein is fibroin.
<3> The molded article according to <2>, wherein the fibroin is derived from a silkworm, a bee, a fly, a spider, or a caddisfly.
<4> A film produced by molding a structural protein, having a water content of 0 to 8.5% by mass.
<5> The film according to <4>, wherein the structural protein is fibroin.
<6> The film according to <5>, wherein the fibroin is derived from a silkworm, a bee, a fly, a spider, or a caddisfly.
<7> A method for preventing a thermal deformation of a molded article Which is produced by molding a structural protein and has a birefringence of 1.0×10⁻⁵ to 10.0−10⁻⁵, the method comprising a step of keeping a water content of the molded article within a range from 0 to 8.5% by mass, when the molded article is heated to 50° C. or higher.
<8> The method for preventing the thermal deformation according to wherein the structural protein is fibroin.
<9> A method for preventing a thermal deformation of a film produced by molding a structural protein, the method comprising a step of keeping a water content of the film within a range from 0 to 8.5% by mass, when the film is heated to 50° C. or higher.
<10> The method for preventing the thermal deformation according to <9>, wherein the structural protein is fibroin.

### Advantageous Effect of the Invention

According to the present invention, the thermal deformation of a molded article produced by molding a structural protein can be prevented.

### BRIEF DESCRIPTION OF THE DRAWINGS

FIG. 1 illustrates a result of thermal gravimetric analysis under respective relative humidity conditions for the silk fibroin film deriving from Bombyx mori.

FIG. 2 illustrates a result of differential scanning calorimetry for the silk fibroin film deriving from Bombyx mori carried out for respective values of the water content thereof.

FIG. 3 illustrates a result of differential scanning calorimetry for the cocoon, silk fibroin, and silk fibroin film deriving from Bombyx mori.

### DESCRIPTION OF THE EMBODIMENTS

Although a detailed description for the present invention will be made with reference to specific examples, the invention is not limited to the following description as long as it does not depart from the spirit of the invention, and it can be modified appropriately to be practiced.

<Molded Article>

A molded article which is an embodiment of the present invention (hereinafter, it may also be abbreviated as “molded article of the invention”) is a molded article produced by molding a structural protein, and is characterized by having a birefringence of 1.0×10⁻⁵ to 10.0×10⁻⁵ and a water content of 0 to 8.5% by mass.

As mentioned above, the present inventors have revealed that the film-like molded article produced from silk fibroin exhibits glass transition points, and further, they have also confirmed that neither silkworm cocoons themselves nor spun silk threads exhibit such glass transition points. This difference may be attributed that highly oriented protein molecules in the silkworm cocoons and the silk threads cause no phase transition whereas protein molecules in the film-like molded article are in a poorly oriented amorphous state, and may cause phase transition into a metastable state, depending on a temperature condition. The value of “birefringence of 1.0×10⁻⁵ to 10.0×10⁻⁵” indicates that the molded article is thus in an amorphous state.

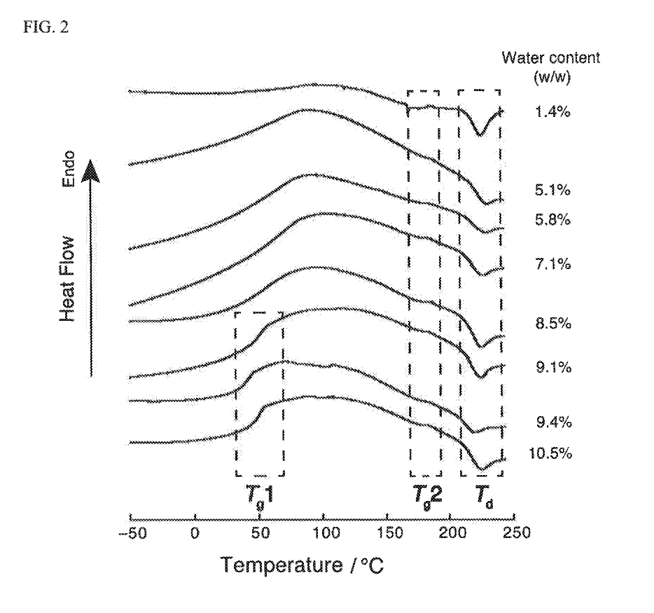

Further, the present inventors have revealed that the glass transition point of the film-like molded article appear when the water content thereof is higher than a certain value, below which they do not appear, and found that the water content below the value hardly causes the thermal deformation of the article. Here, FIG. 2 illustrates a result of differential scanning calorimetry for a silk fibroin film having a water content of 1.4% to 10.5%. It is clearly displayed that the glass transition point at about 50° C. appears when the water content is 9% or more, and that the heat flow on the point depends on the water content. This implies that the water molecules serve as a plasticizer in the protein, inhibiting phase transition in the film having a sufficiently low water content. On the other hand, since the higher glass transition point does not depend on the water content, it may be based on a structural change owing to the hydrophobic interaction of the protein molecules or the cleavage/recombination of hydrogen bonding thereof.

In other words, the molded article of the invention has an excellent property that thermal deformation is unlikely to occur while it is a molded article having a “birefringence of 1.0×10⁻⁵ to 10.0×10⁻⁵.”

The term “structural protein” means a known protein which plays a role of forming and supporting in vivo structures and morphologies.

The term “molding a structural protein” means to process a structural protein into a desired shape as a solid material, and also includes, for example, forming a structural protein layer on the surface of an article.

The molded article of the invention was produced by molding a structural protein, The specific kind of the structural protein and other components contained in the molded article have no particular limitation and can be selected, if appropriate, according to a purpose. Specific examples will be given for explanation, as follows.

Examples of the structural protein include fibroin, collagen, keratin, actin, myosin, and elastin. Among them, fibroin is particularly preferable.

Fibroin may be of any biological origin, and preferably is derived from the silkworm, bees, flies, spiders, and caddisflies. The molded article of the invention is not limited to contain one structural protein and may contain two or more.

The molded article of the invention may contain other components, and examples of the components include sericin contained in silk and calcium oxalate contained in the silkworm cocoon layer.

The content of the structural protein in the molded article of the invention (total content when two or more proteins are contained) is usually 80% by mass or more, preferably 90% by mass or more, and more preferably 95% by mass or more.

The molded article of the invention is a molded article having a birefringence of 1.0−10⁻⁵ to 10.0×10⁻⁵, preferably 2.0×10⁻⁵ or more, more preferably 4.0×10⁻⁵ or more, and still more preferably 5.0×10⁻⁵ or more, and preferably 9.0×10⁻⁵ or less, more preferably 8.0×10⁻⁵ or less, and still more preferably 7.5×10⁻⁵ or less.

The “birefringence” can be obtained from a molded article bonded, for example, to a slide glass, which is used to measure, by using a phase-contrast microscope, a base-line and then retardance, the calculated average and standard deviation of which retardance are divided by the average and standard deviation of the diameter (nm), to calculate the birefringence.

The molded article of the invention is characterized by having a water content of 0 to 8.5% by mass, which is preferably 1.0% by mass or more, and preferably 8.0% by mass or less, and more preferably 7.0% by mass or less. When the water content is within the above range, the thermal deformation can be easily reduced.

<Film >

A film which is another embodiment of the present invention (hereinafter it may be abbreviated as “film of the invention”) is a film produced by molding the structural protein and it is characterized by having a water content of 0 to 8.5% by mass.

As mentioned above, the present inventors revealed that glass transition points appear in the film-like molded silk fibroin and found that when its water content is lower than a certain amount, thermal deformation is unlikely to occur.

In other words, the film of the invention has an excellent property that thermal deformation is unlikely to occur while it is a film produced by molding a structural protein.

The film of the invention is produced by molding a structural protein. The specific kind of the structural protein, other components contained in the film, the content of the structural protein, and the water content are the same as those explained in <Molded article>above.

The thickness of the film of the invention is usually 1.0 μm or more, preferably 5.0 μm or more, and more preferably 15 μm or more.

<Method for Preventing Thermal Deformation>

A method for preventing thermal deformation which is another embodiment of the invention (hereinafter, it may be abbreviated as “prevention method 1 of the invention”) is a method for preventing the thermal deformation of a molded article which is produced by molding the structural protein and has a birefringence of 1.0×10⁻⁵ to 10.0×10⁻⁵, and the method is characterized by keeping the water content of the molded article within a range from 0 to 8.5% by mass, when the molded article is heated to 50° C. or higher.

Similarly, a method for preventing thermal deformation which is still another embodiment of the invention (hereinafter it may be abbreviated as “prevention method 2 of the invention”) is a method for preventing the thermal deformation of a film produced by molding the structural protein, and is characterized by keeping the film content of the molded article within a range from 0 to 8.5% by mass, when the film is heated to 50° C. or higher.

As mentioned above, the present inventors have revealed that a molded article having a “birefringence of 1.0×10⁻⁵ to 10.0×10⁻⁵”, such as the silk fibroin exhibits glass transition points and found that thermal deformation is unlikely to occur when the water content is lower than a specific value.

In other words, when the molded article produced by molding the structural protein is heated to 50° C. or higher, the thermal deformation can be prevented by keeping the water content within a range from 0 to 8.5% by mass.

The prevention methods 1 and 2 of the invention are methods for preventing the thermal deformation of a molded article by molding the structural protein. The specific kind of structural protein, other components contained in the article, the content of the structural protein, and the water content are the same as those explained in <Molded article>above.

The prevention methods 1 and 2 of the invention are characterized by keeping the water content of the molded article within a range from 0 to 8.5% by mass, when the molded article is heated above 50° C. or higher, and means for “keeping the water content within a range from 0 to 8.5% by mass” is not particularly limited, and known means can be adopted if appropriate.

Examples of specific means for “keep the water content within a range from 0 to 8.5% by mass” include those according to (1) to (3) below.

(1) Keeping the humidity of the external environment to 58% or less.

For example, when the molded article is an article which may be heated to 50° C. or higher, the humidity of an environment in which the article is used (external environment) may be reduced to 58% or less, to prevent increase in the water content in the molded article.

(2) Preventing water ingress from the external environment into the molded article.

For example, when the molded article is an article which may be heated to 50° C. or higher, a layer such as a less water-permeable protective layer may be provided on the surface of the molded article, to reduce the amount of water ingress from the external environment into the molded article.

(3) Placing a desiccant inside and/or on the surface of the molded article.

For example, when the molded article is an article which may be heated to 50° C. or higher, a desiccant may be placed inside or on the surface of the molded article, to prevent increase in the water content of molded article (structural protein) itself.

### EXAMPLES

Although the present invention will be described more specifically with reference to Example below, it can be modified, if appropriate, as long as it does not depart from the spirit of the present invention. Therefore, the scope of the present invention should not be construed restrictively by specific examples to be described below.

<Molding Silk Fibroin (Film)>

(1) A cocoon derived from Bombyx mora was fragmented and then stirred in a boiled aqueous solution of 0.02 M sodium carbonate for 30 minutes to remove sericin, a glue component contained in the cocoon, and silk fibroin was yielded,
(2) The silk fibroin was stirred three times in ultrapure water for 30 minutes, and water was squeezed from the silk fibroin, which is then dried at room temperature.
(3) The silk fibroin was incubated at 60° C. for 1 hour to be completely dissolved in an aqueous solution of 9.3 M lithium bromide, and then dialyzed in ultrapure water by using a dialysis membrane having a molecular weight cut off of 6000 to 8000.
(4) The fibroin solution was poured onto a plastic dish and then dried to form a silk fibroin film of 30 μm in thickness.

<Measurement of Birefringence of Silk Fibroin Film>

Birefringence was measured for the obtained silk fibroin film. The measuring method is as follows.

The film was attached to a slide glass by double-sided tapes attached to both ends of the longer sides of the glass, and the base-line and then the retardance of the film were measured by using a phase-contrast microscope. The average value and standard deviation of analyzed values obtained from five times of measurement of the retardance were calculated, and then divided by the average value and standard deviation of the diameter (nm), to calculate birefringence.

The birefringence of the silk fibroin film was 5.2×10⁻⁵ to 7.0×10⁻⁵.

### <Thermal Gravimetric Analysis of Silk Fibroin Film>

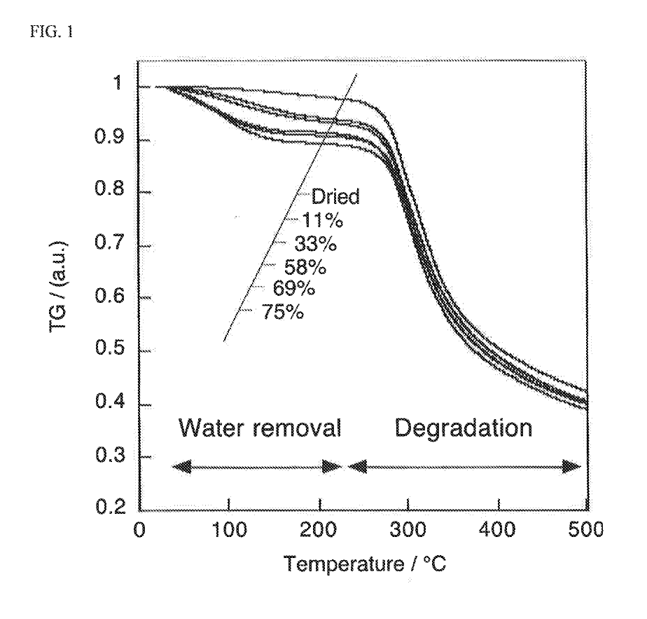

Fabricated silk fibroin films were left stand overnight under various humidities. Each of the humidities was achieved under the coexistence of a saturated salt in a sealed container, and lithium chloride was used for a humidity of 11%, magnesium chloride for 33%, sodium bromide for 58%, potassium iodide for 69%, and sodium chloride for 75%. Further, complete dryness (“Dried” in FIG. 1) was achieved by vacuum dryness at 40° C. overnight.

Thermal gravimetric analysis was carried out for each of the silk fibroin films under nitrogen environment. A “TG/DTA7200” from Seiko Instruments Inc. was used as a thermal gravimetric analyzer, with a scan speed being 20 K/min. The result is illustrated in FIG. 1.

Weight loss was observed owing to the desorption of water molecules bound to silk molecules up to about 220° C. and increased with increase in humidity, This implies that a larger amount of water is held in silk molecules in highly humid conditions. In addition, weight loss owing to the degradation of the film was observed upon further heating.

<Differential Scanning Calorimetry of Silk Fibroin Film>

Similarly, differential scanning calorimetry was carried out for each of the silk fibroin films under nitrogen environment. The differential scanning calorimetry was carried out by using a “DSC 8500” from PerkinElmer, Inc. with a scan speed being 20 K/min. The result is illustrated in FIG. 2.

It is clearly indicated that two glass transition points are observed at about 50° C. and 180° C. It has been revealed that the glass transition point about 50° C. appears when the water content is 9% or more, and that the heat flow on the point depends on the water content. This implies that the water molecules serve as a plasticizer in the protein, preventing phase transition in the film having a sufficiently low water content. On the other hand, since the higher glass transition point does not depend on the water content, it may be accompanied by a structural change owing to the hydrophobic interaction in the fibroin molecules or the cleavage/recombination of hydrogen bonding therein. In addition, a peak was observed at about 220° C., which may be attributed to the thermal degradation of silk fibroin.

<Differential Scanning Calorimetry of Silkworm Cocoon and Fibroin>

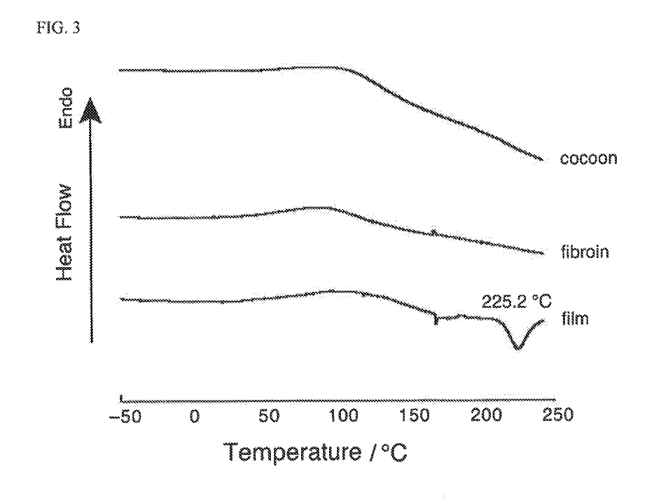

Differential scanning calorimetry was carried out also for a silkworm cocoon and fibroin as comparative examples. Fibroin was prepared from a silkworm cocoon which was treated three times by a process of boiling and stirring the cocoon in 0.02 M sodium carbonate for 30 minutes and successively washing it in water for 30 minutes and then dried at room temperature. The differential scanning calorimetry was carried out by using a “DSC 8500” from PerkinElmer, Inc., with a scan speed being 20 K/min. The result is illustrated in FIG. 3.

Neither the silkworm cocoon nor the fibroin exhibited any specific signature such as transition in temperature scan up to about 240° C. On the other hand, the silk fibroin film having a water content of 1.4% exhibited a peak at about 225° C., which may be attributed to the degradation of the film.

### INDUSTRIAL APPLICABILITY

The molded article of the present invention can be used in, for example, shock absorbing members for automobiles, bulletproofing equipment, and clothing.

1. A molded article produced by molding a material comprising a structural protein, having a birefringence of 1.0×10⁻⁵ to 10.0×10⁻⁵ and a water content of 0 to 8.5% by mass.

2. The molded article according to claim 1, wherein the structural protein is fibroin.

3. The molded article according to claim 2, wherein the fibroin is derived from a silkworm, a bee, a fly, a spider, or a caddisfly.

4. The molded article according to claim 1, wherein the molded article is a film.

5. The molded article according to claim 4, wherein the structural protein is fibroin.

6. The molded article according to claim 5, wherein the fibroin is derived from a silkworm, a bee, a fly, a spider, or a caddisfly.

7. A method for preventing a thermal deformation of a molded article which is produced by molding a material comprising a structural protein and has a birefringence of 1.0×10⁻⁵ to 10.0×10⁻⁵, the method comprising a step of keeping a water content of the molded article within a range from 0 to 8.5% by mass, when the molded article is heated to 50° C. or higher.

8. The method for preventing the thermal deformation according to claim 7, wherein the structural protein is fibroin.

9. A method for preventing a thermal deformation of a film produced by molding a material comprising a structural protein, the method comprising a step of keeping a water content of the film within a range from 0 to 8.5% by mass, when the film is heated to 50° C. or higher.

10. The method for preventing the thermal deformation according to claim 9, wherein the structural protein is fibroin.
